(19) United States
(12) Patent Application Publication
(10) Pub. No.: US 2014/0116836 A1
(43) Pub. Date: May 1, 2014

(54) ROLLER STRUCTURE FOR CONVEYING GLASS SUBSTRATES

(71) Applicant: Shenzhen China Star Optoelectronics Technology Co., Ltd., Shenzhen, Guangdong (CN)

(72) Inventors: Yongqiang Wang, Shenzhen City (CN); Chunhao Wu, Shenzhen City (CN); Kunhsien Lin, Shenzhen City (CN); Minghu Qi, Shenzhen City (CN); Weibing Yang, Shenzhen City (CN); Zenghong Chen, Shenzhen City (CN); Zhenhua Guo, Shenzhen City (CN); Yunshao Jiang, Shenzhen City (CN); Zhiyou Shu, Shenzhen City (CN)

(73) Assignee: Shenzhen China Star Optoelectronics Technology Co., Ltd., Shenzhen, Guangdong (CN)

(21) Appl. No.: 13/699,702

(22) PCT Filed: Nov. 5, 2012
(86) PCT No.: PCT/CN2012/084075

§ 371 Date: Nov. 23, 2012

(30) Foreign Application Priority Data
Oct. 29, 2012 (CN) 201210420211.1

(51) Int. Cl. B65G 13/00

(52) U.S. Cl. CPC B65G 13/00
USPC 193/37

(57) ABSTRACT

A roller structure for conveying glass substrates is disclosed. The roller structure includes a rolling axis and a plurality of rollers fasten to the rolling axis. Two adjacent rollers are arranged at a certain distance. At least one of the rollers includes a main wheel and a secondary wheel coaxially arranged with the main wheel. The main wheel and the secondary wheel have respective support point for conveying the glass substrates. A distance between the two support points and the rolling axis is the same and adjustable. By adding the number of the wheels and the support points in the limited space, the distances between the adjacent support points are reduced.

This application claims priority to China Patent Application No. 201210420211.1 filed on Oct. 29, 2012 entitled, ROLLER STRUCTURE FOR CONVEYING GLASS SUBSTRATES, all of the disclosures of which are incorporated herein by reference in their entirety.

### BACKGROUND OF THE INVENTION

1. Field of the Invention

Embodiments of the present disclosure relate to liquid crystal technology, and more particularly to a roller structure for conveying glass substrates.

2. Discussion of the Related Art

Rollers are usually adopted to convey glass substrates in a manufacturing process of liquid crystal panels. A typical roller structure includes a rolling axis and a plurality of rollers assembled with the rolling axis. FIG. 8 is a cross section view of one typical roller structure for conveying the glass substrates. As the dimension of the glass substrate 91 is large, i.e., the width and the length are above one meter, and the thickness is small, i.e., less than 0.5 mm, the portion of the glass substrate between the two rollers 92 may be deformed and thus the following problems occur.

First, the glass substrates may break into fragments due to shocks in an up-down direction. At the same time, the glass substrates may be scratched due to the frictions between the glass substrates and the rollers. Second, the portions between two rollers may break into fragments as the stresses are concentrated in the portion. Third, as printed circuits are formed in a planar condition, and thus the printed circuits may be deformed or fragmented when the glass substrates are bent.

### SUMMARY

The object of the claimed invention is to provide a roller structure for conveying glass substrates. By adding the number of the wheels and the support points in the limited space, the distances between the adjacent support points are reduced.

In one aspect, a roller structure for conveying glass substrates includes a rolling axis and a plurality of rollers fasten to the rolling axis. Two adjacent rollers are arranged at a certain distance. At least one of the rollers includes: a main wheel; a secondary wheel coaxially arranged with the main wheel, wherein the main wheel and the secondary wheel have respective support point for conveying the glass substrates, a distance between the two support points and the rolling axis is the same; and a washer is arranged between the main wheel and the secondary wheel for adjusting the distance between the two support points.

Wherein embedded slots are arranged on the circumferences of the main wheel and the secondary wheel for receiving rubber rings.

Wherein the main wheel and the secondary wheel comprise: a wheel body; and an axis hole on the wheel body, wherein the circumference of the wheel body contacts with the glass substrate on the support point, and the main wheel and the secondary wheel are fasten to the rolling axis via the axis holes.

Wherein the main wheel comprises a protrusion extended along a direction of the axis hole, the protrusion is on one side of the main wheel, and a fixing hole is arranged on the protrusion for placing a jack screw so as to fasten the roller to the rolling axis.

Wherein the main wheel and the secondary wheel comprise corresponding pinholes, and positioning pins engage with the two pinholes so as to fasten the main wheel and the secondary wheel.

Wherein the main wheel and the secondary wheel are integrally formed.

In another aspect, a roller structure for conveying glass substrates includes a rolling axis and a plurality of rollers fasten to the rolling axis. Two adjacent rollers are arranged at a certain distance. At least one of the rollers includes: a main wheel; a secondary wheel coaxially arranged with the main wheel, wherein the main wheel and the secondary wheel have respective support point for conveying the glass substrates, a distance between the two support points and the rolling axis is the same and adjustable; and the main wheel and the secondary wheel are integrally formed.

Wherein a fixing hole is arranged between the main wheel and the secondary wheel for placing a jack screw so as to fasten the roller to the rolling axis.

Wherein embedded slots are arranged on the circumferences of the main wheel and the secondary wheel for receiving rubber rings.

A roller structure for conveying glass substrates includes a rolling axis and a plurality of rollers fasten to the rolling axis. Two adjacent rollers are arranged at a certain distance. At least one of the rollers includes: a main wheel; and a secondary wheel coaxially arranged with the main wheel, wherein the main wheel and the secondary wheel have respective support point for conveying the glass substrates, a distance between the two support points and the rolling axis is the same and adjustable.

Wherein the main wheel and the secondary wheel comprise: a wheel body; and an axis hole on the wheel body, wherein the circumference of the wheel body contacts with the glass substrate on the support point, and the main wheel and the secondary wheel are fasten to the rolling axis via the axis holes.

Wherein the main wheel comprises a protrusion extended along a direction of the axis hole, the protrusion is on one side of the main wheel, and a fixing hole is arranged on the protrusion for placing a jack screw so as to fasten the roller to the rolling axis.

Wherein the main wheel and the secondary wheel comprise corresponding pinholes, and positioning pins engage with the two pinholes so as to fasten the main wheel and the secondary wheel.

Wherein a washer is arranged between the main wheel and the secondary wheel for adjusting the distance between the two support points.

Wherein a washer is arranged between the main wheel and the secondary wheel for adjusting the distance between the two support points.

Wherein embedded slots are arranged on the circumferences of the main wheel and the secondary wheel for receiving rubber rings.

Wherein the main wheel and the secondary wheel are integrally formed.

Wherein embedded slots are arranged on the circumferences of the main wheel and the secondary wheel for receiving rubber rings.

Wherein the main wheel and the secondary wheel are integrally formed, and a fixing hole is arranged between the main wheel and the secondary wheel for placing a jack screw so as to fasten the roller to the rolling axis.

Wherein embedded slots are arranged on the circumferences of the main wheel and the secondary wheel for receiving rubber rings.

### BRIEF DESCRIPTION OF THE DRAWINGS

FIG. 1 is a cross sectional view of a roller for conveying glass substrates in accordance with a first embodiment.

FIG. 2 is a cross sectional view of a main wheel of the roller in accordance with the first embodiment.

FIG. 3 is a cross sectional view of a secondary wheel of the roller in accordance with the first embodiment.

FIG. 4 is a cross sectional view of the roller assembled with a rubber in accordance with the first embodiment.

FIG. 5 is an enlarged view of portion A in FIG. 4.

FIG. 6 is a cross sectional view of the roller in accordance with a second embodiment.

FIG. 7 is a cross sectional view of the roller in accordance with a third embodiment.

FIG. 8 is a cross sectional view of a typical roller.

### DETAILED DESCRIPTION OF THE EMBODIMENTS

Embodiments of the invention will now be described more fully hereinafter with reference to the accompanying drawings, in which embodiments of the invention are shown.

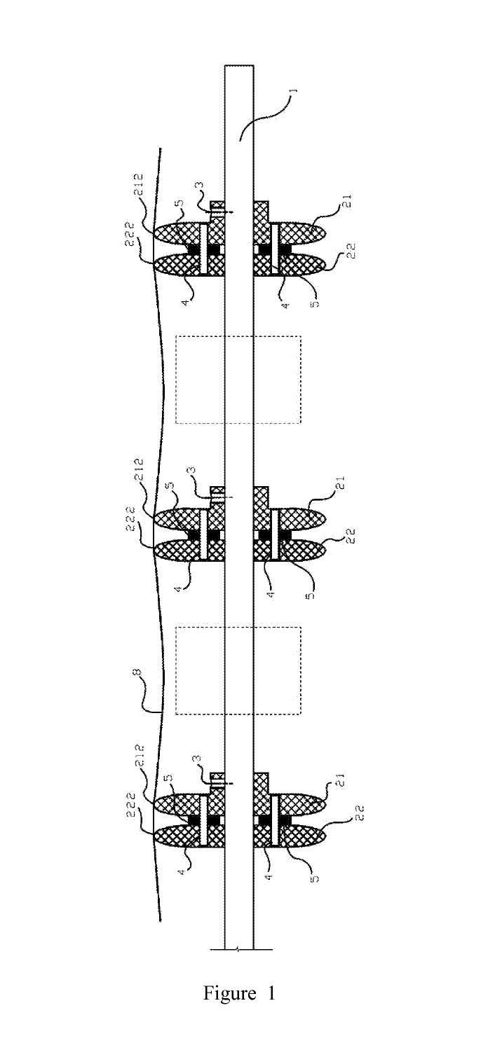

FIGS. 1-4 show the structure of the roller in accordance with a first embodiment. The roller includes a rolling axis 1 and a plurality of wheels.

FIG. 1 is a cross sectional view of a roller structure for conveying glass substrates in accordance with a first embodiment. Threes rollers are fasten to the rolling axis 1. Two adjacent rollers are arranged at a certain distance such that auxiliary components may be installed in the dotted area.

Each of the roller includes a main wheel 21 and a secondary wheel 22 coaxially arranged with the main wheel 21. The main wheel 21 and the secondary wheel 22 are driven synchronously by the rolling axis 1.

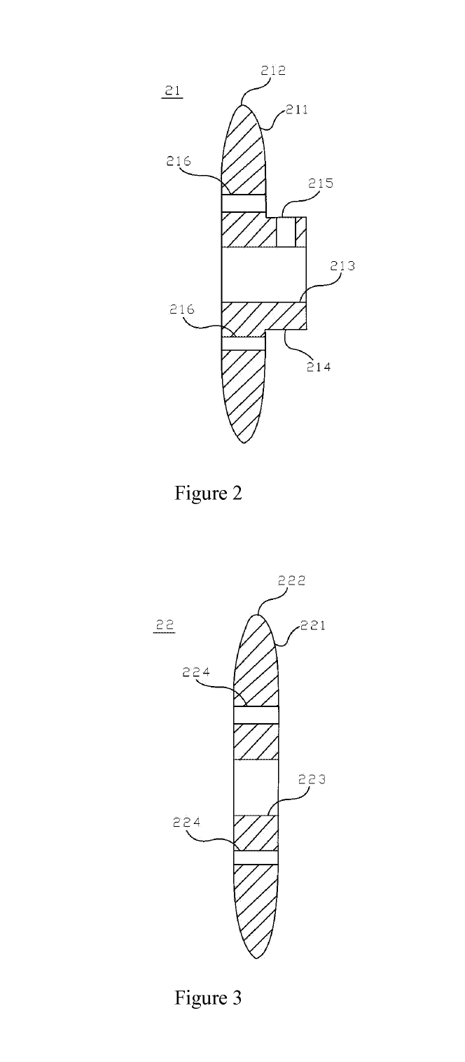

FIG. 2 is a cross sectional view of the main wheel 21. The main wheel 21 includes a wheel body 211 and an axis hole 213. A circumference of the wheel body 211 contacts with a glass substrate 8 on a support point 212 of the main wheel 21.

The axis hole 213 is arranged in a center of the wheel body 211 for engaging with the rolling axis 1. The wheel body 211 is driven synchronously by the rolling axis 1 when the main wheel 21 is assembled to the rolling axis 1. The assembly process of the axis hole 213 and the rolling axis 1 are described below.

The main wheel 21 has a protrusion 214 extended along a direction of the axis hole 213. The protrusion 214 is on one side of the wheel body 211. The protrusion 214 is arranged to increase the contact area between the rolling axis 1 and the axis hole 213. A fixing hole 215 is arranged on the protrusion 214 for placing a jack screw 3, screws, and so son.

In one embodiment, the jack screw 3 is inserted in the fixing hole 215. The edge of the jack screw 3 abuts against the rolling axis 1 such that the main wheel 21 and the rolling axis 1 are fasten together.

The wheel body 211 of the main wheel 21 includes at least two pinholes 216. FIG. 3 is a cross sectional view of a secondary wheel of the roller in accordance with the first embodiment. The secondary wheel 22 includes the wheel body 221 and the axis hole 223. The circumference of the wheel body 221 contacts with the glass substrate 8 on the support point 222 of the secondary wheel 22.

The axis hole 223 is arranged in a center of the wheel body 221 for engaging with the rolling axis 1.

The secondary wheel 22 is driven synchronously by the rolling axis 1 when the main wheel 22 is assembled to the rolling axis 1. The assembly process of the secondary wheel 22 and the main wheel 21 are described below.

Pinholes 224 are arranged on the wheel body 221 of the secondary wheel 22 according to the pinholes 216 of the wheel body 211 of the main wheel 21. When the main wheel 21 and the secondary wheel 22 engage with the rolling axis 1 via the axis holes 213, 223, the pinholes 216, 224 align with each other. Positioning pins 4 engage with the pinholes 216, 214 so as to fasten the main wheel 21 and the secondary wheel 22. As such, the main wheel 21 and the secondary wheel 22 are driven synchronously by the rolling axis 1.

As the distances between the support points 212 of the main wheel 21 and the rolling axis 1, and between the support points 222 of the secondary wheel 22 and the rolling axis 1 are the same for all of the rollers, and thus the support points 212, 222 is in a same plane surface. By adding the number of the supporting points in the limited space, the distances between the support points are reduced such that the glass substrates are prevented from breaking into fragments due to deformations.

Further, a washer 5 is arranged between the main wheel 21 and the secondary wheel 22.

The distances between the support point 212 and the support point 222 may be adjusted by changing a thickness of the washer 5. For example, as the thickness of the washer 5 is increased, the distances between the support points of the adjacent rollers are reduced. As such, the distances between the two support points on the glass substrate are reduced.

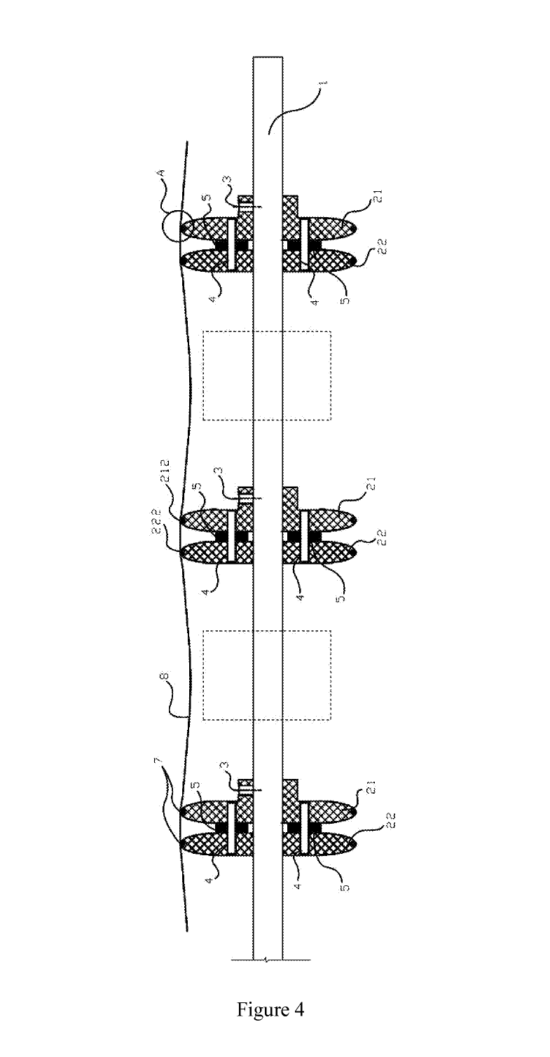

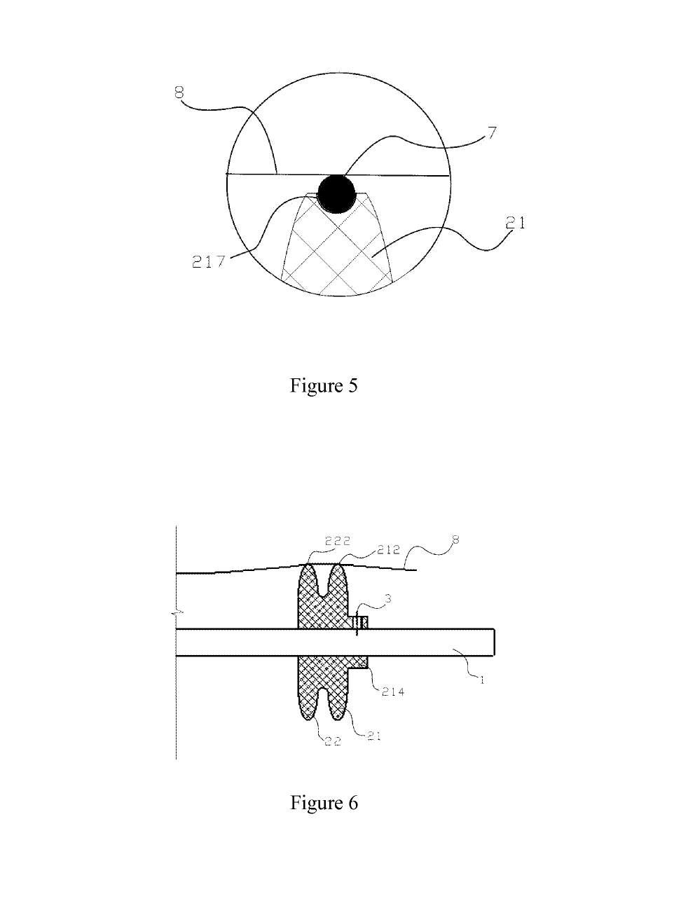

In other embodiment, embedded slots 217 are arranged on the circumferences of the wheel body 211 of the main wheel 21 and that of the wheel body 221 of the secondary wheel 22. In addition, one O-shaped rubber ring 7 is placed in one embedded slot 217 as shown in FIGS. 4 and 5.

The O-shaped rubber ring 7 prevents the glass substrate 8 from being scratched due to imprecise dimensions or harsh surfaces of the rollers. As such, the rollers may reduce the impact of shocks. In addition, the O-shaped rubber ring 7 also increases frictions between the support points 212, 222 and the glass substrate 8.

FIG. 6 is a cross sectional view of a roller in accordance with a second embodiment. The secondary wheel 22 is integrally formed with the main wheel 21. In this way, the distance between the support points 212, 222 to the rolling axis 1 is the same. In addition, the step of assembling the secondary wheel 22 with the main wheel 21 is omitted so as to simplify the process.

In the embodiment, the distance between the support point 212 and the support point 222 is fixed. Thus, the step of assembling the washer with the wheels is also omitted.

It is to be understood that the main wheel 21 and the secondary wheel 22 may have corresponding embedded slots for receiving the O-shaped rubber ring 7.

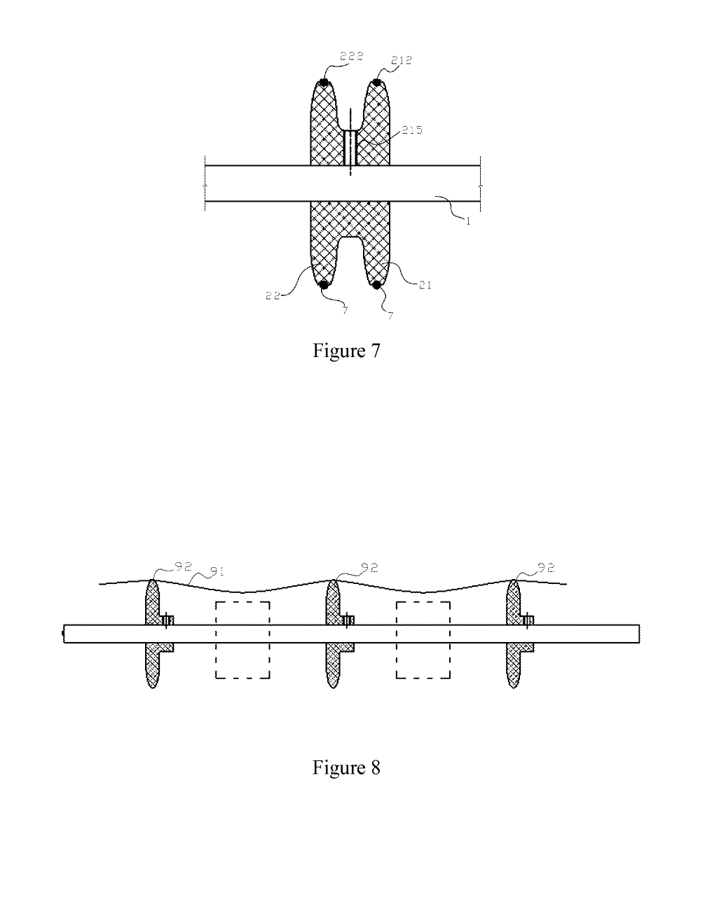

FIG. 7 is a cross sectional view of the roller in accordance with a third embodiment.

In the embodiment, the secondary wheel 22 is formed integrally with the main wheel 21.

The fixing hole 215 is arranged in a location between the main wheel 21 and the secondary wheel 22. The jack screw 3 is inserted in the fixing hole 215. The edge of the jack screw 3 abuts against the rolling axis 1 such that the roller and the rolling axis 1 are fasten together.

In the embodiment, the main wheel 21 and the secondary wheel 22 may have corresponding embedded slots for receiving the O-shaped rubber ring 7.

The main wheel and the secondary wheel are coaxially arranged. Both of the main wheel and the secondary wheel have its own support point. The distances between the support points to the rolling axis are the same, and the distance between the two support points is adjustable. By adding the number of the wheels and the support points in the limited space, the distances between the adjacent support points are reduced. As such, the glass substrates are prevented from fragment due to deformations.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A roller structure for conveying glass substrates, comprising:
a rolling axis and a plurality of rollers fasten to the rolling axis, two adjacent rollers are arranged at a certain distance, and at least one of the rollers comprises:
a main wheel;
a secondary wheel coaxially arranged with the main wheel, wherein the main wheel and the secondary wheel have respective support point for conveying the glass substrates, a distance between the two support points and the rolling axis is the same; and
a washer is arranged between the main wheel and the secondary wheel for adjusting the distance between the two support points.

2. The roller structure as claimed in claim 1, wherein embedded slots are arranged on the circumferences of the main wheel and the secondary wheel for receiving rubber rings.

3. The roller structure as claimed in claim 2, wherein the main wheel and the secondary wheel comprise:
a wheel body; and
an axis hole on the wheel body, wherein the circumference of the wheel body contacts with the glass substrate on the support point, and the main wheel and the secondary wheel are fasten to the rolling axis via the axis holes.

4. The roller structure as claimed in claim 3, wherein the main wheel comprises a protrusion extended along a direction of the axis hole, the protrusion is on one side of the main wheel, and a fixing hole is arranged on the protrusion for placing a jack screw so as to fasten the roller to the rolling axis.

5. The roller structure as claimed in claim 4, wherein the main wheel and the secondary wheel comprise corresponding pinholes, and positioning pins engage with the two pinholes so as to fasten the main wheel and the secondary wheel.

6. The roller structure as claimed in claim 5, wherein the main wheel and the secondary wheel are integrally formed.

7. A roller structure for conveying glass substrates, comprising:
a rolling axis and a plurality of rollers fasten to the rolling axis, two adjacent rollers are arranged at a certain distance, at least one of the rollers comprises:
a main wheel;
a secondary wheel coaxially arranged with the main wheel, wherein the main wheel and the secondary wheel have respective support point for conveying the glass substrates, a distance between the two support points and the rolling axis is the same and adjustable; and
the main wheel and the secondary wheel are integrally formed.

8. The roller structure as claimed in claim 7, wherein a fixing hole is arranged between the main wheel and the secondary wheel for placing a jack screw so as to fasten the roller to the rolling axis.

9. The roller structure as claimed in claim 8, wherein embedded slots are arranged on the circumferences of the main wheel and the secondary wheel for receiving rubber rings.

10. A roller structure for conveying glass substrates, comprising:
a rolling axis and a plurality of rollers fasten to the rolling axis, two adjacent rollers are arranged at a certain distance, at least one of the rollers comprises:
a main wheel; and
a secondary wheel coaxially arranged with the main wheel, wherein the main wheel and the secondary wheel have respective support point for conveying the glass substrates, a distance between the two support points and the rolling axis is the same and adjustable.

11. The roller structure as claimed in claim 10, wherein the main wheel and the secondary wheel comprise:
a wheel body; and
an axis hole on the wheel body, wherein the circumference of the wheel body contacts with the glass substrate on the support point, and the main wheel and the secondary wheel are fasten to the rolling axis via the axis holes.

12. The roller structure as claimed in claim 11, wherein the main wheel comprises a protrusion extended along a direction of the axis hole, the protrusion is on one side of the main wheel, and a fixing hole is arranged on the protrusion for placing a jack screw so as to fasten the roller to the rolling axis.

13. The roller structure as claimed in claim 11, wherein the main wheel and the secondary wheel comprise corresponding pinholes, and positioning pins engage with the two pinholes so as to fasten the main wheel and the secondary wheel.

14. The roller structure as claimed in claim 12, wherein a washer is arranged between the main wheel and the secondary wheel for adjusting the distance between the two support points.

15. The roller structure as claimed in claim 13, wherein a washer is arranged between the main wheel and the secondary wheel for adjusting the distance between the two support points.

16. The roller structure as claimed in claim 11, wherein embedded slots are arranged on the circumferences of the main wheel and the secondary wheel for receiving rubber rings.

17. The roller structure as claimed in claim 11, wherein the main wheel and the secondary wheel are integrally formed.

18. The roller structure as claimed in claim 17, wherein embedded slots are arranged on the circumferences of the main wheel and the secondary wheel for receiving rubber rings.

19. The roller structure as claimed in claim 11, wherein the main wheel and the secondary wheel are integrally formed, and a fixing hole is arranged between the main wheel and the secondary wheel for placing a jack screw so as to fasten the roller to the rolling axis.

20. The roller structure as claimed in claim 19, wherein embedded slots are arranged on the circumferences of the main wheel and the secondary wheel for receiving rubber rings.
